(19) United States
(12) Patent Application Publication
(10) Pub. No.: US 2019/0155991 A1
(43) Pub. Date: May 23, 2019

(54) EMPLOYING A MULTI-MODALITY ALGORITHM TO GENERATE RECOMMENDATION INFORMATION ASSOCIATED WITH HOSPITAL DEPARTMENT SELECTION

(71) Applicant: International Business Machines Corporation, Armonk, NY (US)

(72) Inventors: Xiang Li, Beijing (CN); Xiu Li Li, Beijing (CN); Guo Tong Xie, Xi Er Qi (CN); Xiaolu Zhang, Beijing (CN); Shi Wan Zhao, Beijing (CN)

(21) Appl. No.: 15/817,507

(22) Filed: Nov. 20, 2017

(51) Int. Cl. G06F 19/00

(52) U.S. Cl. CPC G06F 19/327; G06F 19/321; G06N 99/005; G06F 19/345; G06F 19/322

(57) ABSTRACT

Systems, computer-implemented methods and/or computer program products that facilitate hospital department selection are provided. In one embodiment, a computer-implemented method comprises: employing, by a system operatively coupled to a processor, machine learning to train a model on data, wherein the data comprises patient data for a patient, hospital department designation associated with the patient and clinical data relating to a patient outcome, and wherein the model is trained to evaluate the hospital department designation associated with the patient based on the clinical data relating to the patient outcome; generating, by the system, a classification by classifying the patient into hospital department; and comparing, by the system, the model to the classification to provide a hospital department selection for the patient.

### BACKGROUND

The subject disclosure relates employing a multi-modality algorithm to generate recommendation information associated with hospital department selection.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate hospital department selection.

According to one embodiment, a system is provided. The system can comprise a memory that stores computer executable components. The system can also comprise a processor, operably coupled to the memory, and that can execute computer executable components stored in the memory. The computer executable components can comprise a model generation component that can employ machine learning to train a model on data, wherein the data comprises patient data for a patient, hospital department designation associated with the patient and clinical data relating to a patient outcome, and wherein the model is trained to evaluate the hospital department designation associated with the patient based on the clinical data relating to the patient outcome. The computer executable components can further comprise a classification component that can generate a classification by classifying the patient into hospital department. The computer executable components can further comprise a selection component that can compare the model to the classification to provide a hospital department selection for the patient.

According to another embodiment, a computer-implemented method is provided. The computer-implemented method can comprise employing, by a system operatively coupled to a processor, machine learning to train a model on data, wherein the data comprises patient data for a patient, hospital department designation associated with the patient and clinical data relating to a patient outcome, and wherein the model is trained to evaluate the hospital department designation associated with the patient based on the clinical data relating to the patient outcome. The computer-implemented method can further comprise generating, by the system, a classification by classifying the patient into hospital department. The computer-implemented method can further comprise comparing, by the system, the model to the classification to provide a hospital department selection for the patient.

According to another embodiment, a computer program product for facilitating hospital department selection is provided. The computer program product can comprise a computer readable storage medium having program instructions embodied therewith. The program instructions can be executable by a processor to cause the processor to employ machine learning to train a model on data, wherein the data comprises patient data for a patient, hospital department designation associated with the patient and clinical data relating to a patient outcome, and wherein the model is trained to evaluate the hospital department designation associated with the patient based on the clinical data relating to the patient outcome. The program instructions can further be executable by a processor to cause the processor to generate a classification by classifying the patient into hospital department. The program instructions can further be executable by a processor to cause the processor to compare the model to the classification to provide a hospital department selection for the patient.

### DESCRIPTION OF THE DRAWINGS

FIG. 1 illustrates a block diagram of an example, non-limiting system facilitating hospital department selection in accordance with one or more embodiments described herein.

FIG. 2 illustrates a block diagram of an example, non-limiting system facilitating hospital department selection including an analysis component in accordance with one or more embodiments described herein.

FIG. 3 illustrates an example, non-limiting computer-implemented method facilitating hospital department selection in accordance with one or more embodiments described herein.

FIG. 4 illustrates a block diagram of an example, non-limiting system facilitating preparing patient data in accordance with one or more embodiments described herein.

FIG. 5 illustrates a block diagram of an example, non-limiting system facilitating hospital department selection in accordance with one or more embodiments described herein.

FIG. 6 illustrates a block diagram of an example, non-limiting system facilitating patient classification in accordance with one or more embodiments described herein.

FIG. 7 illustrates an example, non-limiting computation of a multi-modality explanation in accordance with one or more embodiments described herein.

FIG. 8 illustrates a block diagram of an example, non-limiting operating environment in which one or more embodiments described herein can be facilitated.

FIG. 9 illustrates a block diagram of an example, non-limiting cloud computing environment in accordance with one or more embodiments described herein.

FIG. 10 illustrates a block diagram of example, non-limiting abstraction model layers in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

One or more embodiments of the subject disclosure describes utilizing machine learning systems to facilitate hospital department selection in accordance with one or more embodiments described herein.

Hospital department selection is widely desired in telemedicine. It is usually used by primary hospitals (e.g., local hospitals) to apply for a more specific department in top hospitals (e.g., larger hospitals). One or more embodiments described and/or claimed herein utilize machine learning systems that have been explicitly or implicitly trained to learn, determine and/or infer hospital department designation associated with a patient and dynamically provide hospital department selection for the patient to facilitate satisfying the needs of the patient and desired outcome. For example, and as will be described in greater detail below, in one or more embodiments, patient data, hospital department designation associated with the patient and/or clinical data relating to patient outcome are some of the many factors that can be taken into consideration by the machine learning system in connection with providing hospital department selection that satisfy the needs of the patient and desired outcome.

The subject disclosure is directed to computer processing systems, computer-implemented methods, apparatus and/or computer program products that facilitate efficiently and automatically (e.g., without direct human involvement) providing hospital department selection for the patient to achieve suiting needs of the patient and desired outcome. Humans are also unable to perform the embodiments described herein as they include, and are not limited to, performing, e.g., complex Markov processes, Bayesian analysis, or other artificial intelligence-based techniques based on probabilistic analyses and evaluating electronic information indicative of hospital department selection to suit the needs of the patient and desired outcome, and/or determining whether countless multitudes of probability values assigned to hospital department selection exceed or fall below various defined probability values.

The computer processing systems, computer-implemented methods, apparatus and/or computer program products employ hardware and/or software to solve problems that are highly technical in nature. For example, problems are related to automated processing, determining or inferring hospital department designation associated with a patient. These problems are not abstract and cannot be performed as a set of mental acts by a human. For example, a human, or even thousands of humans, cannot efficiently, accurately and effectively manually apply countless or thousands of patient outcome variables to input points and perform analysis to determine that a probability value assigned to hospital department selection proposed to suit the needs of the patient and desired outcome exceeds a defined threshold.

To aid in the numerous inferences described herein (e.g., inferring hospital department designation), components described herein can examine the entirety or a subset of data to which it is granted access and can provide for reasoning about or inferring states of a system, environment, etc., from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in construction of new events or actions from a set of observed events and/or stored event data, whether the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., na\ddot{v}e Bayes, Bayesian networks, decision trees, neural networks, fuzzy logic models, and probabilistic classification models providing different patterns of independence can be employed. Classification as used herein also is inclusive of statistical regression that is utilized to develop models of priority.

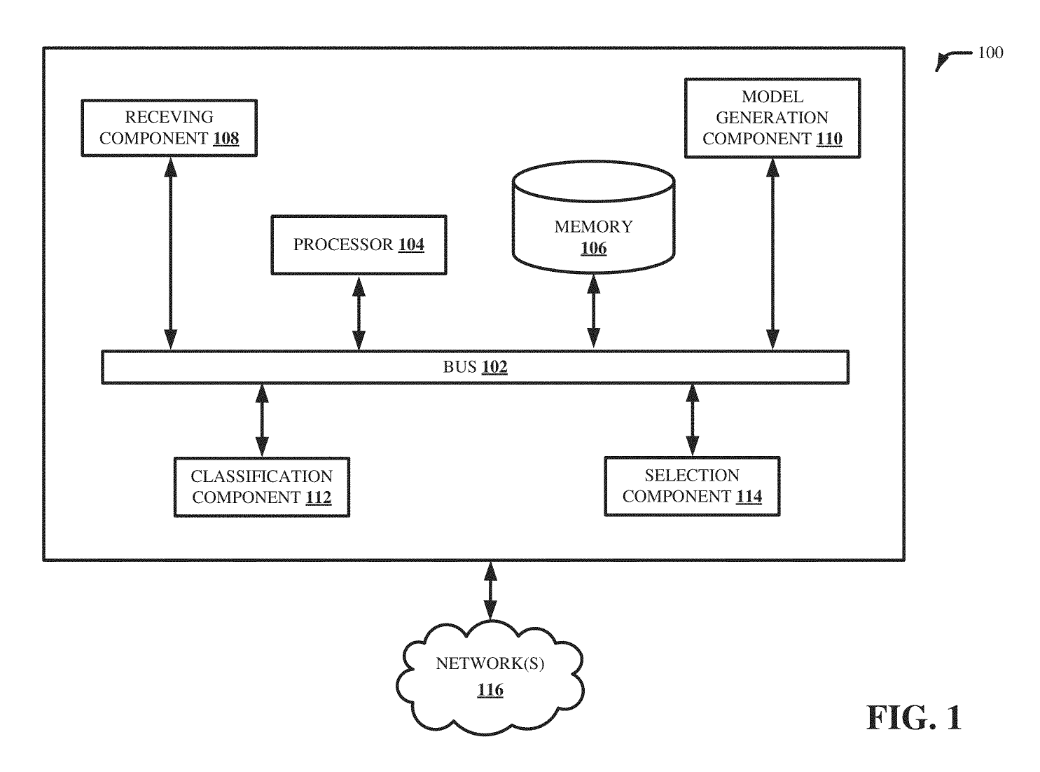

FIG. 1 illustrates a block diagram of an example, non-limiting system 100 facilitating hospital department selection in accordance with one or more embodiments described herein. Aspects of systems (e.g., non-limiting system 100 and the like), apparatuses or processes explained in this disclosure can constitute machine-executable components embodied within machines, e.g., embodied in one or more computer readable mediums (or media) associated with one or more machines. Such components, when executed by the one or more machines, e.g., computers, computing devices, virtual machines, etc., can cause the machines to perform the operations described.

In various embodiments, the system 100 can be any type of component, machine, device, facility, apparatus, and/or instrument that comprises a processor. In some embodiments, system 100 is capable of effective and/or operative communication with a wired and/or wireless network. Components, machines, apparatuses, devices, facilities, and/or instrumentalities that can comprise the system 100 can include, but are not limited to, tablet computing devices, handheld devices, server class computing machines and/or databases, laptop computers, notebook computers, desktop computers, cell phones, smart phones, consumer appliances and/or instrumentation, industrial and/or commercial devices, digital assistants, multimedia Internet enabled phones, multimedia players, and the like.

The system can include a bus 102 that can provide for interconnection of various components of the system 100. It is to be appreciated that in other embodiments one or more system components can communicate wirelessly with other components, through a direct wired connection or integrated on a chipset. The system can include a processor 104 and memory 106 that can carry out computational and/or storage operations of the system 100 as described herein.

A receiving component 108 can receive information (e.g., through one or more internal and external networks 116 (wired or wireless networks)). A receiving component 108 can receive patient data for the patient, hospital department designation associated with the patient, and clinical data relating to patient outcome. The patient data can include name, age, diagnosis, medical history, etc. Clinical data relating to patient outcome can include data collected during the course of ongoing care or as part of a clinical trial as the result of medical treatment. A patient can be associated with a hospital department designation when the patient is assigned to a hospital department within a hospital for medical treatment. Different hospitals can have different naming systems for designated hospital departments. Furthermore, larger hospitals can have more departments that are more specific to the types of medical treatment, whereas, smaller hospitals can have fewer, more general departments. In addition to receiving information associated with the patient, the receiving component 108 can also receive information regarding different hospitals, medical professionals and information relevant to the prevention, mitigation and treatment of diseases. For example, information relevant to the treatment of diseases can be digital imaging and communications in medicine (DICOM) images and text or electronic health record (EHR) data. The received data can be used as recommendation factors for selecting a hospital department for the patient. Recommendation factors can be received patient data, clinical data, hospital department designation, etc. The recommendation factors can be shared for patients with the same disease based on past recommendation history. For example, two patients with the same medical condition can be assigned to the same hospital department within the same hospital.

A model generation component 110 can generate the models and employ machine learning to train the models on data received by the receiving component 108. The models can be generated by linking the patients with selected hospital departments for medical treatments. The model generation component 110 can train the models on patient data for the patient, hospital department designation associated with the patient and clinical data relating to a patient outcome. In some embodiments, the models can be trained to evaluate the hospital department designation associated with the patient based on the clinical data relating to the patient outcome. More specifically, the models can be trained to evaluate the hospital department selected for the patient by analyzing the clinical data to determine the effectiveness of the medical treatment associated with the selected hospital department. For example, the models can evaluate the effectiveness of treatment for a patient who has a bone fracture and is sent to the orthopedics department versus another patient who also has a bone fracture but is sent to the general surgery department.

The model generation component 110 can also generate feedback based on the evaluation of the hospital department designation associated with the patient. For example, the feedback for the effectiveness of the hospital department selection or recommendation can be positive (e.g., well cured), negative (e.g., not cured), reevaluation required (e.g., results rejected or need to double check the effectiveness of the treatment), etc.

The model generation component 110 can also employ recursive learning in connection with training the models. The models can perform a utility-based analysis that factors the benefits associated with making a correct hospital department selection against the costs of making an incorrect hospital department selection. The utility-based analysis can weigh the cost benefit of selecting one department over another. The models can be cross-trained against other models in a cloud-based infrastructure.

A classification component 112 can generate classifications by classifying the patient into hospital department. The classification can comprise a first type of classification, features of the patient (e.g., patient features) and a second type of classification. The first type of classification can comprise a rough classification that can perform the classification using the DICOM images. The classification component 112 can perform a rough classification or generate a rough classification by classifying the DICOM images into different modalities, e.g., different organs, tissues, etc. For example, the DICOM images from mammograms, ultrasounds and magnetic resonance imaging (MRI) of the bosom can be classified under mammary gland lesions.

The classification component 112 can generate features of the patient (e.g., patient features) based on text or EHR data. The text or EHR data can be analyzed to help classify the data into normal (e.g., benign), sick (e.g., cancerous), etc., based on the features described in the EHR. For example, the text or EHR data (e.g., written description) of a breast exam can be classified as cancerous if signs of breast cancer are present. In addition, the features of the patient can also include other information about the patient including, but not limited to, the age, weight, height of the patient.

The second type of classification can comprise a fine classification. The classification component 112 can perform a fine classification or generate a fine classification by analyzing the first type of classification (e.g., rough classification) and the features of the patient (e.g., patient features). The fine classification can classify the patients into hospital departments. For example, the classification component 112 can generate a rough classification to classify a patient as having breast lesions. The classification component 112 can generate features of the patient as being an older patient with breast cancer. The classification component 112 can analyze the rough classification (e.g., breast lesions) and features of the patient (e.g., older patient with breast cancer) to generate a fine classification to classify that the patient has breast cancer and recommend the oncology department.

A selection component 114 can compare the models (e.g., generated via the model generation component 110) to the fine classifications (e.g., generated via the classification component 112) to provide a hospital department selection for the patient. The selection component 114 can employ the feedback (e.g., well cured, not cured, etc.) generated by the model generation component 110 and the hospital department inferred by the classification component 112 to rate the hospital department selection. For example, if the classification component 112 inferred the oncology department for a patient with breast cancer and the model generation component 110 also find similar patients transferred to the oncology department with high treatment results, then the oncology department selection will have a high rating. The selection component 114 can generate three hospital department selection with the highest rating and indicate the best hospital department selection.

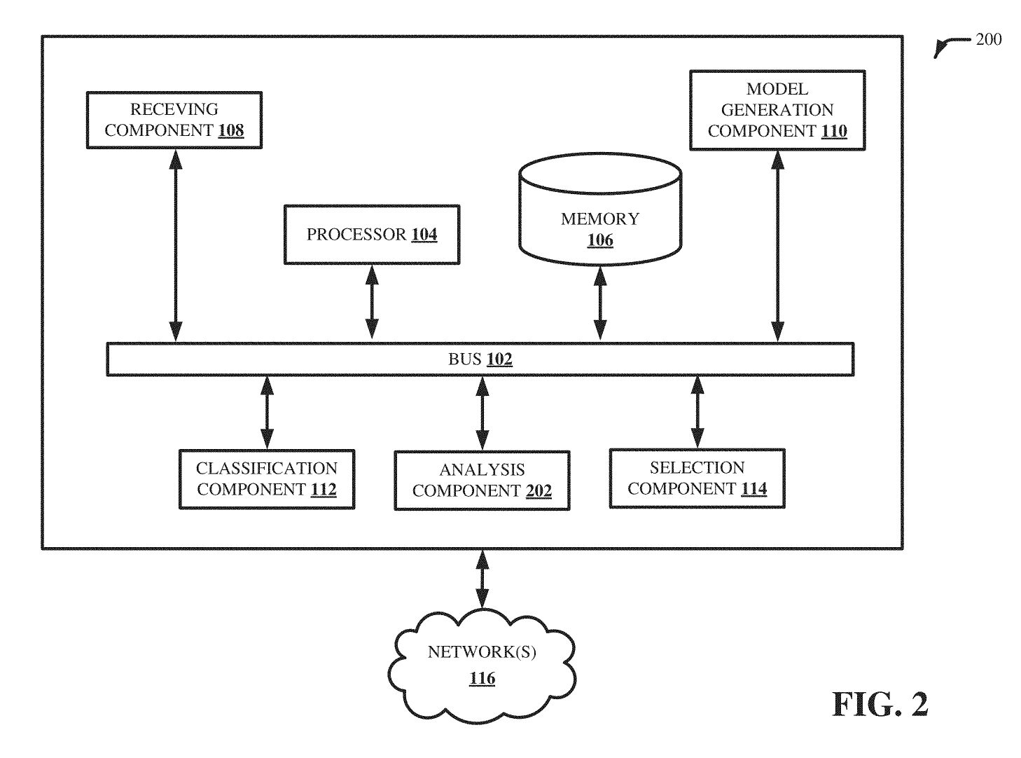

FIG. 2 illustrates a block diagram of an example, non-limiting system 200 facilitating hospital department selection including an analysis component 202 in accordance with one or more embodiments described herein. The analysis component 202 can compute and generate a multi-modality explanation by employing the following equation (e.g., a multi-modality algorithm):

$$L ( {z}_{1 … i} , {x}_{1 … i} , y ) = ‖ {\sum }_{i} {f}_{i} ( {z}_{i} , {x}_{i} ) - y ‖ + {\sum }_{i} Ω ( {z}_{i} ) .$$

A DICOM image is a type of modality input and a text or EHR is another type of modality input. The modalities are represented as i in the multi-modality algorithm. Images and EHR data are multi-modality. Each modality data can infer some information about the patient, and the above algorithm can be employed to obtain entire information about the patient and make a recommendation. The variable z, represents an attention item for each modality; the variable x, represents signal value for each modality such as image pixel value and EHR column value; the variable y represents the label task such as classification result; and the variable Ω₁ represents the penalty item.

The combination of the DICOM images and the text or EHR data can be considered a multi-modality. A modality (e.g., a DICOM image or a text or EHR data) data can infer some information about a patient. The multi-modality algorithm can be used to learn the entire information about the patient and make a recommendation.

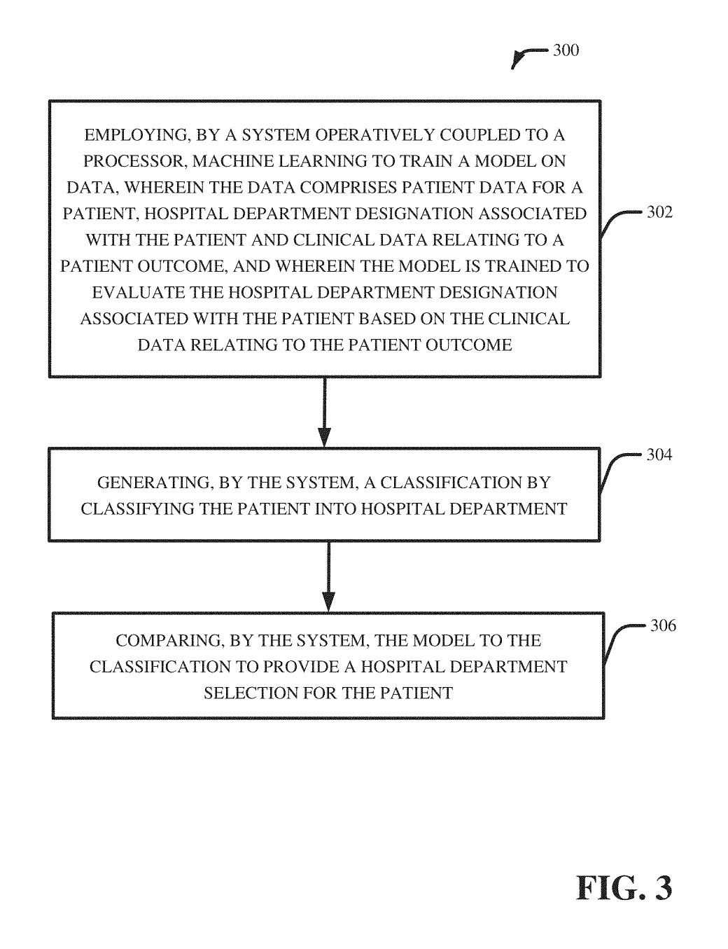

FIG. 3 illustrates an example, non-limiting computer-implemented method facilitating hospital department selection in accordance with one or more embodiments described herein. At 302, the computer-implemented method 300 can comprise employing (e.g., via the model generation component 110), by a system operatively coupled to a processor, machine learning to train a model on data, wherein the data comprises patient data for a patient, hospital department designation associated with the patient and clinical data relating to a patient outcome, and wherein the model is trained to evaluate the hospital department designation associated with the patient based on the clinical data relating to the patient outcome. At 304, the computer-implemented method 300 can comprise generating (e.g., via the classification component 112), by the system, a classification by classifying the patient into hospital department. At 306, the computer-implemented method 300 can comprise comparing (e.g., via the selection component 114 ), by the system, the model to the classification to provide a hospital department selection for the patient.

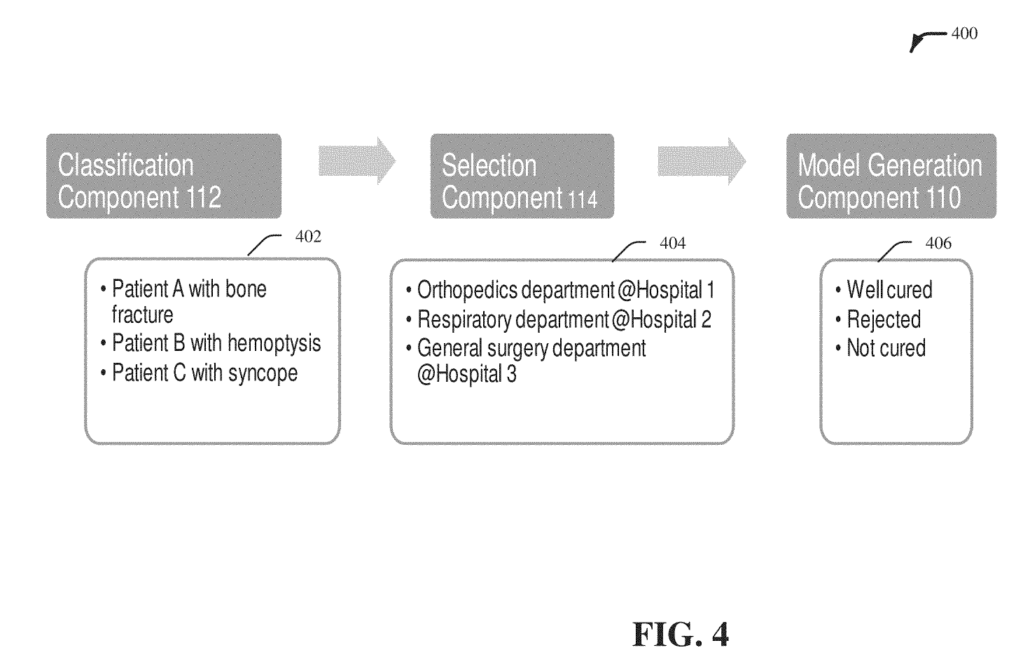

FIG. 4 illustrates a block diagram of an example, non-limiting system 400 facilitating preparing patient data in accordance with one or more embodiments described herein. In this example, the local hospital 402 has three patients: Patient A, Patient B and Patient C. The classification component 112 can generate rough classifications and features of the patients indicating that Patient A has a bone fracture, Patient B has hemoptysis and Patient C has syncope. The rough classification and features of the patient can be based on the DICOM images and the text or EHR data, respectively. The classification component 112 can further generate fine classifications that classify the patients into hospital departments (not shown) by analyzing the rough classifications and the features of the patients.

The selection component 114 can compare the models and the fine classifications to provide a hospital department selection for the patients. As illustrated here in FIG. 4, the selection component 114 can select hospital departments in the top hospital 404 for the patients from the local hospital 402. The selection component 114 can select for Patient A who has a bone fracture the orthopedics department at Hospital 1. For Patient B who has hemoptysis, the selection component 114 can select for Patient B the respiratory department at Hospital 2. Patient C has syncope (e.g., fainting), and the selection component 114 can select for Patient C the general surgery department at Hospital 3. Without more information, the cause of the syncope can be one of at least several reasons. For example, a syncope can be caused by a cardiac condition or a non-cardiac condition. Therefore, the selection component 114 can employ the utility-based analysis from the models to select the general surgery department rather than selecting a more specific department that could be wrong and end up costing more money.

The model generation component 110 can generate feedback 406. The feedback 406 states that Patient A is well cured, Patient B is rejected (e.g., reevaluation of the hospital department selection required) and Patient C is not cured. The feedback can be generated based on the evaluation of the hospital department designation associated with the patient. For example, a patient designated to a selected hospital department has a positive feedback if upon evaluation of the clinical data relating to the patient outcome, the patient is well cured.

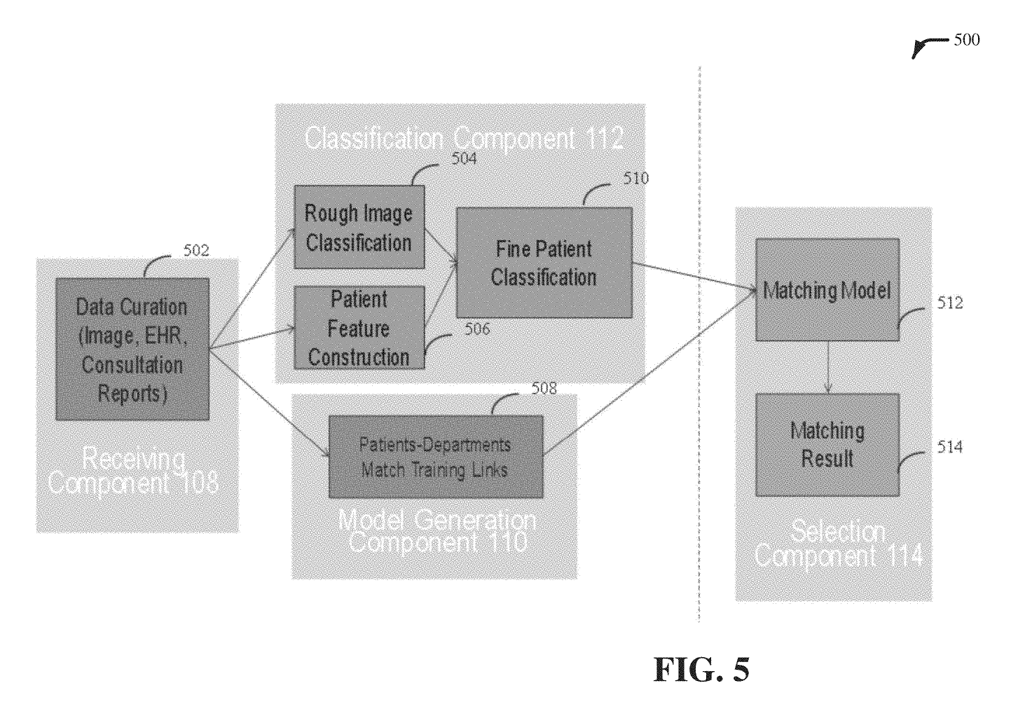

FIG. 5 illustrates a block diagram of an example, non-limiting system 500 facilitating hospital department selection in accordance with one or more embodiments described herein. The receiving component 108 can receive data curation 502, which can include image (e.g., DICOM images), EHR (e.g., text or EHR data) and consultation reports (e.g., from consultation request for hospital department selection). The model generation component 110 can employ the data curation 502, received by the receiving component 108, to generate the patients-departments match training links 508 (e.g., the models). The patients-departments match training links 508 (e.g., the models) can be generated by linking or matching the patient with the hospital department designation associated with the patient. The classification component 112 can employ the DICOM images to generate the rough image classification 504. The classification component 112 can also employ text or EHR data to perform patient feature construction 506. The classification component 112 can analyze the rough image classification 504 and the patient feature construction 506 to generate the fine patient classification 510.

The selection component 114 can perform a matching model 512 (e.g., compare) the patients-departments match training links 508 (e.g., the models) and the fine patient classification 510 to provide the matching result 514 (e.g., hospital department selection for the patient).

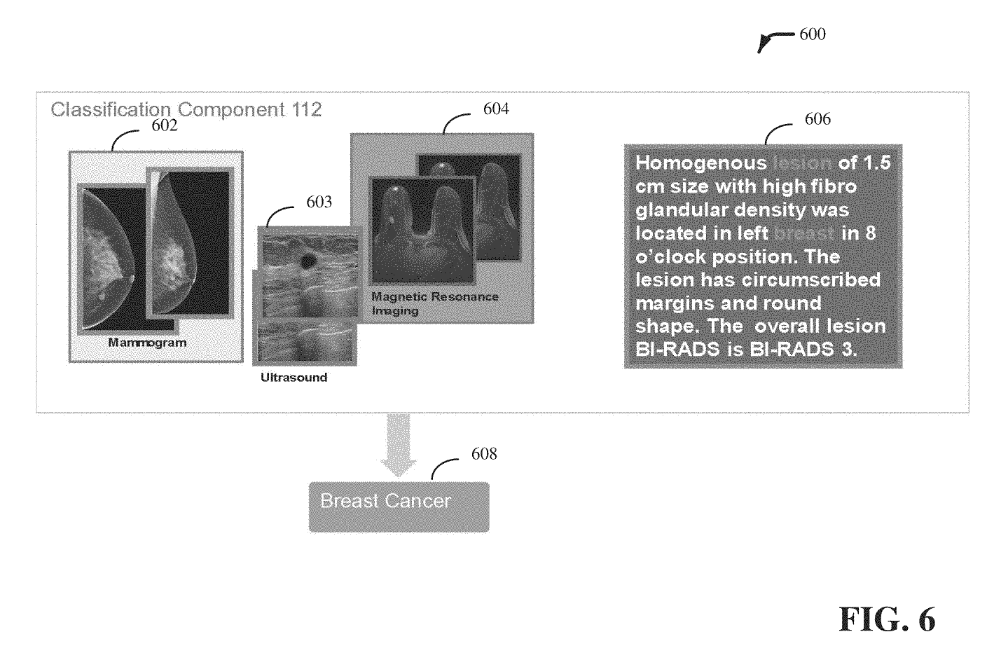

FIG. 6 illustrates a block diagram of an example, non-limiting system 600 facilitating patient classification in accordance with one or more embodiments described herein.

The patient classification in FIG. 6 is a fine classification generated by the classification component 112. The system 600 can employ (e.g., via the classification component 112) the DICOM image 602, the DICOM image 603, the DICOM image 604 and the text or EHR data 606 to generate patient classification (e.g., a fine classification). The fine classification can be generated by analyzing the rough classification and the features of the patient. The rough classification can be generated from the DICOM images. The DICOM images can be, but is not limited to, mammogram, ultrasound and MRI. For example, the DICOM image 602 is a mammogram. The DICOM image 603 is an ultrasound. The DICOM image 604 is an MRI. Based on the DICOM images 602, 603 and 604, the classification component 112 can generate a rough classification that the patient is probably benign for the breast cancer examination.

The features of the patient (e.g., patient features) can be generated from the text or EHR data. The text or EHR data can be a written description of a breast exam. For example, the text or EHR data 606 states that there is a homogenous lesion of 1.5 centimeter (cm) in size with high fibro granular density located in the left breast at the 8 o'clock position. The lesion has circumscribed margins and a circular (or spherical) shape. The overall lesion breast imaging reporting and data system (BI-RADS) is a BI-RADS 3. BI-RADS assessment categories are range from 0 to 6. A BI-RADS 3 means that the finding is probably benign for the breast cancer examination.

The classification component 112 can analyze rough classifications and features of the patient to generate fine classifications. The selection component 114 can compare models and fine classifications to generate hospital department selections. In the example from FIG. 6, based on the rough classification and the features of the patient resulting in a reading that the patient is benign for breast cancer, the classification component can generate a fine classification that the patient is benign for breast cancer 608 and recommend follow-up in the imaging department for additional imaging tests.

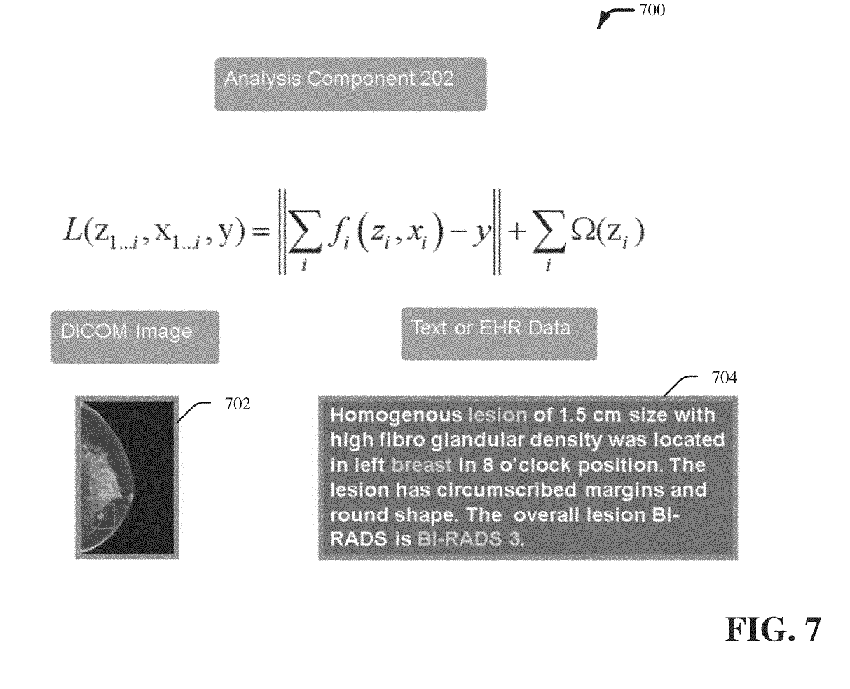

FIG. 7 illustrates an example, non-limiting computation 700 of a multi-modality explanation in accordance with one or more embodiments described herein. The analysis component 202 can employ DICOM images (e.g., DICOM image 702) and text or EHR data (e.g., text or EHR data 704) to generate a multi-modality explanation.

The analysis component 202 can compute an attention over modalities and a modality-specified attention by using the multi-modality algorithm that can incorporate DICOM images (e.g., DICOM image 702) and text or EHR data (e.g., text or EHR data 704). An attention over modalities means there can be different modalities. Whereas, a modality-specified attention can refer to a specific attention with a single modality. For example, the multi-modality algorithm or equation

$$L ( {z}_{1 … i} , {x}_{1 … i} , y ) = ‖ {\sum }_{i} {f}_{i} ( {z}_{i} , {x}_{i} ) - y ‖ + {\sum }_{i} Ω ( {z}_{i} )$$

is a multi-modality explanation that can incorporate DICOM image 702 and text or EHR data 704. The modalities (e.g., DICOM image 702 and text or EHR data 704) are represented as i in the multi-modality algorithm.

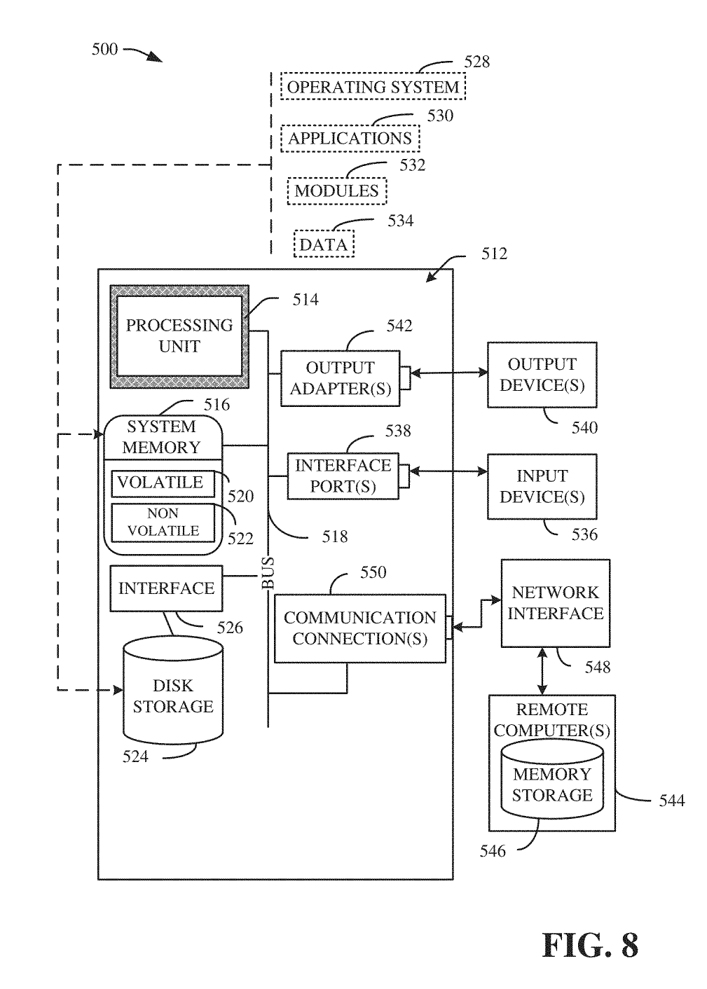

In order to provide a context for the various aspects of the disclosed subject matter, FIG. 8 as well as the following discussion are intended to provide a general description of a suitable environment in which the various aspects of the disclosed subject matter can be implemented. FIG. 8 illustrates a block diagram of an example, non-limiting operating environment in which one or more embodiments described herein can be facilitated. Repetitive description of like elements employed in other embodiments described herein is omitted for sake of brevity.

With reference to FIG. 8, a suitable operating environment 800 for implementing various aspects of this disclosure can also include a computer 812. The computer 812 can also include a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814. The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 816 can also include volatile memory 820 and nonvolatile memory 822. The basic input/output system (BIOS), containing the basic routines to transfer information between elements within the computer 812, such as during start-up, is stored in nonvolatile memory 822. Computer 812 can also include removable/non-removable, volatile/non-volatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media. To facilitate connection of the disk storage 824 to the system bus 818, a removable or non-removable interface is typically used, such as interface 826. FIG. 8 also depicts software that acts as an intermediary between users and the basic computer resources described in the suitable operating environment 800. Such software can also include, for example, an operating system 828. Operating system 828, which can be stored on disk storage 824, acts to control and allocate resources of the computer 812.

System applications 830 take advantage of the management of resources by operating system 828 through program modules 832 and program data 834, e.g., stored either in system memory 816 or on disk storage 824. It is to be appreciated that this disclosure can be implemented with various operating systems or combinations of operating systems. A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port can be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor based appliance, a peer device or other common network node and the like, and typically can also include many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to the system bus 818. While communication connection 850 is shown for illustrative clarity inside computer 812, it can also be external to computer 812. The hardware/software for connection to the network interface 848 can also include, for exemplary purposes only, internal and external technologies such as, modems including regular telephone grade modems, cable modems and DSL modems, ISDN adapters, and Ethernet cards.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off- premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

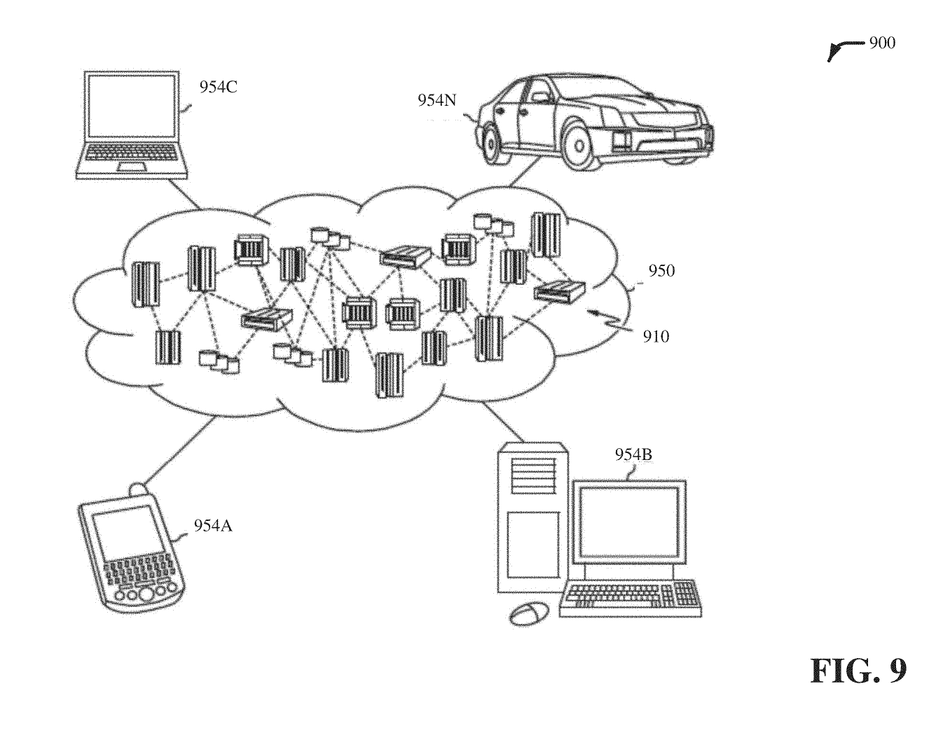

Referring now to FIG. 9, an illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

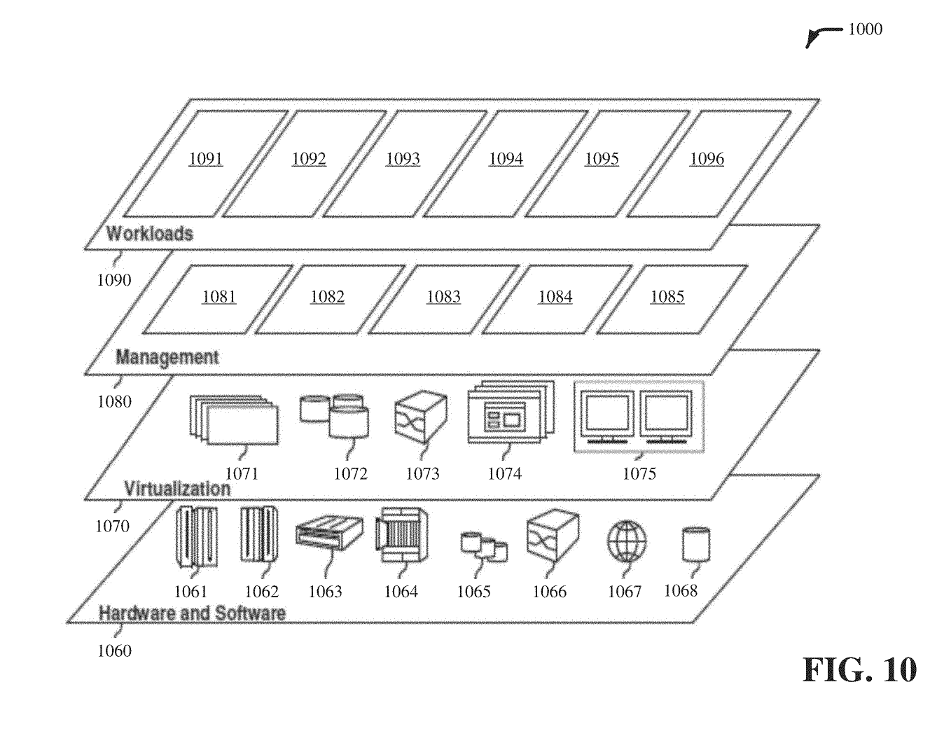

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Non-limiting examples of workloads and functions which may be provided from this layer include: mapping and navigation 1091; software development and lifecycle management 1092; virtual classroom education delivery 1093; data analytics processing 1094; transaction processing 1095; and mobile desktop 1096.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field- programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single- core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor, operably coupled to the memory, and that executes computer executable components stored in the memory, wherein the computer executable components comprise:
a model generation component that employs machine learning to train a model on data, wherein the data comprises patient data for a patient, a hospital department designation associated with the patient and clinical data relating to a patient outcome, and wherein the model is trained to evaluate the hospital department designation associated with the patient based on the clinical data relating to the patient outcome;
a classification component that generates a classification by classifying the patient into a hospital department; and
a selection component that compares the model to the classification to provide a hospital department selection for the patient.

2. The system of claim 1, wherein the model also generates feedback based on evaluation of the hospital department designation associated with the patient, and wherein the feedback is used to rate the hospital department selection.

3. The system of claim 1, wherein the patient data comprises Digital Imaging and Communications in Medicine (DICOM) images, wherein the classification comprises a first type of classification, and wherein the first type of classification comprises a rough classification that performs the classification using the DICOM images.

4. The system of claim 3, wherein the classification also comprises features of the patient based on text or Electronic Health Record (EHR) data.

5. The system of claim 4, wherein the classification comprises a second type of classification, and wherein the second type of classification comprises a fine classification based on the first type of classification and the features of the patient.

6. The system of claim 1, wherein the computer executable components further comprise an analysis component that computes attention over modalities using the following equation:
$$L ( {z}_{1 … i} , {x}_{1 … i} , y ) = ‖ {\sum }_{i} {f}_{i} ( {z}_{i} , {x}_{i} ) - y ‖ + {\sum }_{i} Ω ( {z}_{i} ) .$$

7. The system of claim 1, wherein the model generation component employs recursive learning to train the model.

8. The system of claim 1, wherein the model is cross-trained against other models in a cloud-based infrastructure.

9. A computer-implemented method, comprising:
employing, by a system operatively coupled to a processor, machine learning to train a model on data, wherein the data comprises patient data for a patient, hospital department designation associated with the patient and clinical data relating to a patient outcome, and wherein the model is trained to evaluate the hospital department designation associated with the patient based on the clinical data relating to the patient outcome;
generating, by the system, a classification by classifying the patient into hospital department; and
comparing, by the system, the model to the classification to provide a hospital department selection for the patient.

10. The computer-implemented method of claim 9, further comprising generating feedback based on evaluation of the hospital department designation associated with the patient, wherein the feedback is used to rate the hospital department selection.

11. The computer-implemented method of claim 9, wherein the patient data comprises Digital Imaging and Communications in Medicine (DICOM) images, wherein the classification comprises a first type of classification, wherein the first type of classification comprises a rough classification that performs the classification using the DICOM images.

12. The computer-implemented method of claim 11, wherein the classification also comprises features of the patient based on text or Electronic Health Record (EHR) data.

13. The computer-implemented method of claim 12, wherein the classification comprises a second type of classification, wherein the second type of classification comprises a fine classification based on the first type of classification and the features of the patient.

14. The computer-implemented method of claim 9, further comprising computing attention over modalities using the following equation:
$$L ( {z}_{1 … i} , {x}_{1 … i} , y ) = ‖ {\sum }_{i} {f}_{i} ( {z}_{i} , {x}_{i} ) - y ‖ + {\sum }_{i} Ω ( {z}_{i} ) .$$

15. A computer program product for facilitating hospital department selection, the computer program product comprising a computer readable storage medium having program instructions embodied therewith, the program instructions executable by a processor to cause the processor to:
employ machine learning to train a model on data, wherein the data comprises patient data for a patient, hospital department designation associated with the patient and clinical data relating to a patient outcome, and wherein the model is trained to evaluate the hospital department designation associated with the patient based on the clinical data relating to the patient outcome;
generate a classification by classifying the patient into hospital department; and
compare the model to the classification to provide a hospital department selection for the patient.

16. The computer program product of claim 15, wherein the program instructions are further executable to cause the processor to:
generate feedback based on evaluation of the hospital department designation associated with the patient, wherein the feedback is used to rate the hospital department selection.

17. The computer program product of claim 15, wherein the patient data comprises Digital Imaging and Communications in Medicine (DICOM) images, wherein the classification comprises a first type of classification, wherein the first type of classification comprises a rough classification that performs the classification using the DICOM images.

18. The computer program product of claim 17, wherein the classification also comprises features of the patient based on text or Electronic Health Record (EHR) data.

19. The computer program product of claim 18, wherein the classification comprises a second type of classification, wherein the second type of classification comprises a fine classification based on the first type of classification and the features of the patient.

20. The computer program product of claim 16, wherein the program instructions are further executable to cause the processor to:
compute attention over modalities using the following equation:
$$L ( {z}_{1 … i} , {x}_{1 … i} , y ) = ‖ {\sum }_{i} {f}_{i} ( {z}_{i} , {x}_{i} ) - y ‖ + {\sum }_{i} Ω ( {z}_{i} ) .$$
